(19) United States
(12) Patent Application Publication
(10) Pub. No.: US 2014/0120507 A1
(43) Pub. Date: May 1, 2014

(54) Psyche Trainer and Method of Use

(71) Applicants: William J. HORVATINOVICH, San Diego, CA (US); Brian E. LABUS, Waukegan, IL (US)

(72) Inventors: William J. HORVATINOVICH, San Diego, CA (US); Brian E. LABUS, Waukegan, IL (US)

(21) Appl. No.: 13/932,908

(22) Filed: Jul. 1, 2013

Related U.S. Application Data
(60) Provisional application No. 61/718,873, filed on Oct. 26, 2012.

(51) Int. Cl. G09B 19/00

(52) U.S. Cl. CPC G09B 19/00
USPC 434/236

(57) ABSTRACT

A psyche trainer has at least one spherical body positioned within a container. The container is attached to a cord, such that the psyche trainer can be worn on a desired appendage of a user. A goal is determined by the user and associated with the psyche trainer. As the user moves, the at least one spherical body traverses along the interior of the container, creating vibrations. The vibrations are registered in the user's brain and act as reminder of the goal, assisting the user in becoming self aware of their goal. The psyche trainer can also be designed to create an audible noise to further assist in becoming self aware of one's goal. As an alternative to being worn by the user, the container may be attached to a support base, such that the psyche trainer may be attached to a variety of objects.

The current application claims a priority to the U.S. Provisional Patent application Ser. No. 61/718,873 filed on Oct. 26, 2012.

### FIELD OF THE INVENTION

The present invention relates generally to a device used to train one's psyche. More specifically, the present invention is a psyche trainer that is activated by the movements of its user. Furthermore, the present invention takes advantage of a user's sense of touch and sound in order to reinforce desired habits and/or achieve desired goals.

### BACKGROUND OF THE INVENTION

Often times people try to break old habits or alter current habits. Usually it is only a matter of will power for the person to change the habit, such as quitting smoking, chewing tobacco, etc. Other times it is a person's forgetfulness preventing them from changing habits, such as bad posture. A constant reminder of the goal trying to be achieved is needed. One needs to be aware of their goal in order to have success in achieving said goal. If the objective or goal of an individual is constantly in their mind, then they are able to focus their attention to it in order to achieve it.

Therefore it is the object of the present invention to provide a device to train one's psyche. The psyche trainer comprises at least one spherical body positioned within a container. Movement of the user translates into the motion of the at least one spherical body in the container. Vibrations of the at least one spherical body traveling through the container register with the nervous system of a user and in turn register with the user's brain. In this way, the psyche trainer acts as a constant reminder to aide a user in forming desired habits. The psyche trainer can also be made to produce an audible noise as another sensory cue used in conjunction with the vibrations that are created.

### BRIEF DESCRIPTION OF THE DRAWINGS

FIG. 1 is a perspective view of the psyche trainer in the preferred embodiment of the present invention.

FIG. 2 is a perspective view of the psyche trainer having a ball bearing as an end cap.

FIG. 3 is a perspective view of the psyche trainer having end caps with attachment loops.

FIG. 4 is a front elevational view of the psyche trainer attached to a cord.

FIG. 5 is a front sectional view of the psyche trainer having a dampener attached to each end cap.

FIG. 6 is a front sectional view of the psyche trainer having an inner spring.

FIG. 7 is a front elevational view of the psyche trainer having a fluid filled guiding volume.

FIG. 8 is a perspective view of the psyche trainer connected to a support base designed to be attached to a pencil.

FIG. 9 is a perspective view of the psyche trainer connected to a support base that comprises a suction cup.

FIG. 10 is a sectional view of the psyche trainer having a visual circuit positioned within the first end cap.

FIG. 11 is a diagram depicting the electrical connection between the at least one battery and the resistor, the bulb, and the pair of contacts.

FIG. 12 is a flowchart describing a method of using the psyche trainer, wherein vibrations and an audible noise are used as sensory cues.

### DETAIL DESCRIPTIONS OF THE INVENTION

All illustrations of the drawings are for the purpose of describing selected versions of the present invention and are not intended to limit the scope of the present invention.

The present invention is a psyche trainer that is used to train one's mind and reinforce desired habits. The psyche trainer comprises a container 1 and at least one spherical body 11. Any material may be used to construct the container 1 and the at least one spherical body 11. In the preferred embodiment of the present invention, the container 1 is transparent, such that the at least one spherical body 11 can be seen traversing the interior of the container 1, however, the container 1 may also be semi-transparent or opaque. Additionally, the psyche trainer can be constructed to any size and designed in any color or design. While the psyche trainer can be used in an almost unlimited number of applications, it is used primarily as a behavior modification tool. Other applications of the present invention include use as a physical therapy device, a physical fitness device, a psychological therapy device, an erotic device, a communications device (i.e. Morse code) or as jewelry.

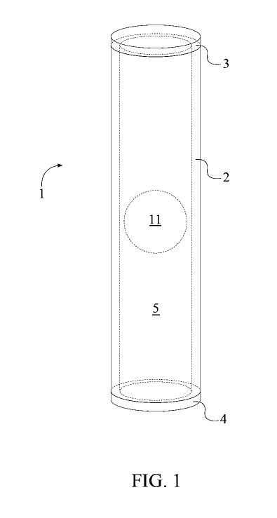

In reference to FIG. 1, the at least one spherical body 11 rests inside the container 1 and is appropriately sized to allow for free movement from end to end of the container 1. The container 1 comprises a tubular body 2, a first end cap 3, a second end cap 4, and a guiding volume 5. The tubular body 2 defines the shape of the psyche trainer and is an elongated cylindrical tube, however, the tubular body 2 can be any other shaped tube. The first end cap 3 is adjacently connected to the tubular body 2, while the second end cap 4 is adjacently connected to the tubular body 2 opposite of the first end cap 3. The first end cap 3 and the second end cap 4 can be sealed in place using any number of materials, such as glue or epoxy, or secured in place using any other method of connection. Together, the tubular body 2, first end cap 3, and second end cap 4 form an enclosure with an open interior. The guiding volume 5 is the open interior, positioned within the tubular body 2 and in between the first end cap 3 and the second end cap 4. The at least one spherical body 11 is movably positioned within the guiding volume 5, such that the at least one spherical body 11 may traverse along the interior of the tubular body 2 from the first end cap 3 to the second end cap 4. As the at least one spherical body 11 traverses the tubular body 2, vibrations are created, which can be felt by the user of the psyche trainer. In the preferred embodiment of the present invention, the at least one spherical body 11 is a bearing ball, however, it is possible for the at least one spherical body 11 to be any number of other shapes or objects.

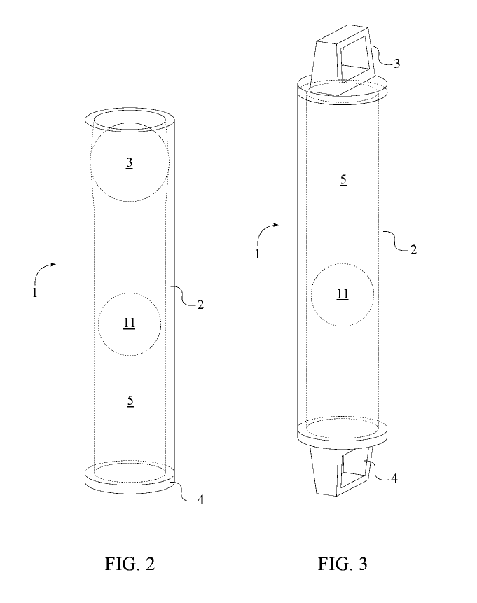

In reference to FIG. 2, in one embodiment of the present invention, the first end cap 3 is a bearing ball, while the second end cap 4 is a fixed end of the container 1. The diameter of the bearing ball forming the first end cap 3 is larger than the inner diameter of the tubular body 2 such that the bearing ball can be press fit into the end of the tubular body 2. In this way, the bearing ball is secured in place by a frictional means and acts as the first end cap 3 for the container 1. The tubular body 2 has one open end in which the bearing ball is positioned and a closed end. This closed end of the tubular body 2 forms the second end cap 4. When the at least one spherical body 11 is a metallic or hard object, an audible noise is produced as the at least one spherical body 11 contacts the bearing ball forming the first end cap 3. Any number of other end caps can be used so long as they prevent the at least one spherical body 11 from leaving the tube.

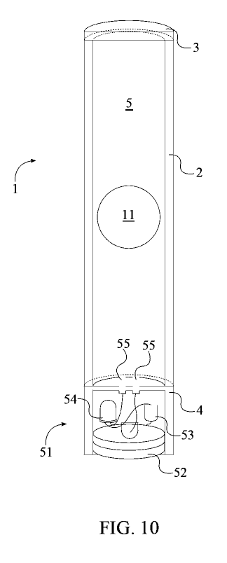

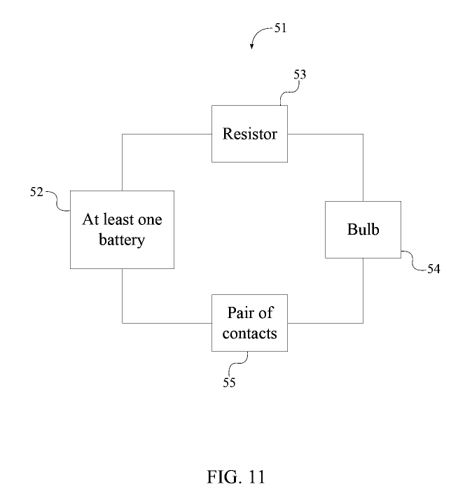

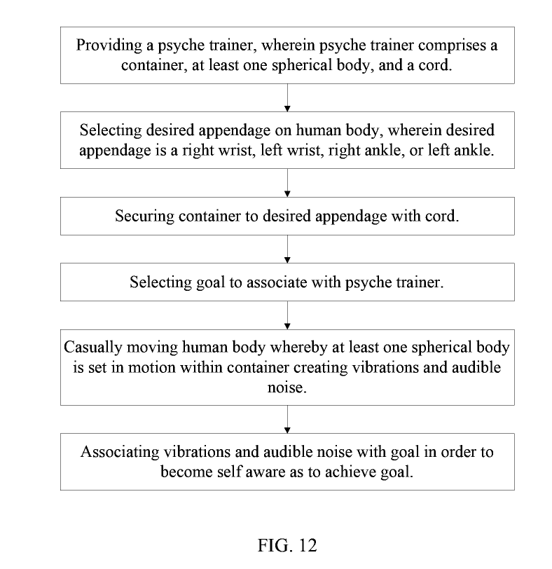

In reference to FIG. 10-11, in some embodiments, the first end cap 3 comprises a visual circuit 51, which is used to produce a third sensory cue. The visual circuit comprises at least one battery 52, a resistor 53, a bulb 54, and a pair of contacts 55. The at least one battery 52 provides electrical current to power the other visual circuit 51 components and, as such, the at least one battery 52 is electrically connected to the resistor 53, the bulb 54, and the pair of contacts 55. The at least one battery 52, the resistor 53, and the bulb 54 are positioned within the first end cap 3, while the pair of contacts 55 is positioned within the guiding volume 5 on the first end cap 3. Together, the pair of contacts 55 and the at least one spherical body 11 act as the switch for the visual circuit 51. When the at least one spherical body 11 engages the pair of contacts 55, the visual circuit 51 is completed and current is supplied through the resistor 53 to the bulb 54. As current is supplied to the bulb 54, the bulb 54 emits light, which illuminates the tubular body 2 and creates a visual signal for the user. The resistor 53 ensures that the proper amount of current is supplied to the bulb 54 while the visual circuit 51 is closed. In the preferred embodiment of the present invention, the bulb 53 is a light emitting diode of a variety of colors, however, any other light source may also be used.

In reference to FIG. 4, the psyche trainer can be worn as a bracelet, anklet or other piece of jewelry or fashion accessory. When worn as a bracelet or an anklet, the psyche trainer further comprises a cord 21, which can be different colors and offer different designs in order to provide stylistic options to the user. The cord 21 comprises a first fastening end 22 and a second fastening end 23. The first fastening end 22 is attached to the first end cap 3, while the second fastening end 23 is attached to the second end cap 4. The cord 21 can be permanently fixed to the container 1 or temporarily attached. In the embodiment shown in FIG. 4, the first fastening end 22 and the second fastening end 23 are tubular sections of the cord 21 that are fitted around the first end cap 3 and the second end cap 4 respectively. However, the first fastening end 22 and/or second fastening end 23 can also be a clasp or other type of fastening device that allows a user to readily attach or remove the psyche trainer from their body. It is also possible for the cord 21 to be made of a stretchable material such that the cord 21 is slipped over a user's wrist or ankle and is one size fits all.

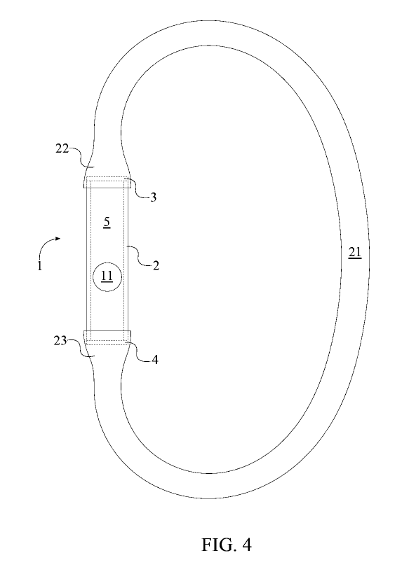

The psyche trainer can also be worn as other types of jewelry or fashion accessories, such as a necklace or a pair of earrings. For example, either the first end cap 3 or the second end cap 4 can form or comprise a hook directed outwards from the container 1. In this way, the psyche trainer can be worn as an earring. The psyche trainer can also feature a first end cap 3 and/or second end cap 4 with fixed loops, as shown in FIG. 3, which would allow the psyche trainer to be used as a keychain. Having one or two fixed loops also allows the psyche trainer to be attached to a number of other different objects or used interchangeably with different necklace chains, key chains, belts, pieces of jewelry, etc.

In reference to FIG. 10, in the preferred method of use, the psyche trainer is worn by a user as either a bracelet or an anklet. A desired appendage on the human body, being either a right wrist, left wrist, right ankle or left ankle, is first selected. The container 1 is then secured to the desired appendage using the provided cord 21. Once the container 1 is secured to the desired appendage, the user may select a goal to associate with the psyche trainer. Casual motion of the user then causes the at least one spherical body 11 within the container 1 to move from one end to another. Resultantly, vibrations are created from the at least one spherical body 11 traversing along the guiding volume 5 of the container 1. The vibrations are then picked up by the user's sensory system and registered in the user's brain, where they are associated with the user's goal. This allows the user to become self aware of their goal, which in turn allows them to more readily achieve their goal. As vibrations are created and registered every time a user moves, a constant reminder of the habit that the individual is trying to reinforce is created. For example, a user may use the psyche trainer to improve their posture. Whenever the user moves as they are sitting down they will be reminded to keep better posture. The more a user moves, the more often vibrations are created and registered and thus the more the habit is reinforced. The psyche trainer also produces an audible noise when the at least one spherical body 11 comes in contact with the first end cap 3 and the second end cap 4 of the container 1. In this way, an audible signal is also picked up by the user's sensory system and registered in their brain. This helps to further enhance a user's self awareness and thus reinforce desired habits.

The psyche trainer may also have a visual circuit 51 in the preferred method of use. The visual circuit 51 provides a third sensory cue that is registered by the user. As the user moves their body, the at least one spherical body 11 traverses along the guiding volume 5. In this way, the at least one spherical body 11 periodically engages the pair of contacts 55 on the first end cap 3 and completes the visual circuit 51. When the visual circuit 51 is closed, the bulb 54 emits light, which acts as a visual signal to the user. Similar to the vibrations and the audible noise, the visual signal is picked up by the user's sensory system, registered in the user's brain, and associated with the user's goal.

In the preferred method of use, the cord 21 provided has a predetermined length. In order to obtain the correct length, the cord 21 is first measured around the desired appendage. The cord 21 is then trimmed in order to snuggly fit around the desired appendage. The cord 21 should have a snug fit so that the container 1 remains in contact with the user, such that the user can feel the vibrations created by the psyche trainer. Once the cord 21 is trimmed to the appropriate length, the first fastening end 22 is attached to the first end cap 3 of the container 1. The cord 21 is then encircled around the desired appendage, and the second fastening end 23 is attached to the second end cap 4 of the container 1.

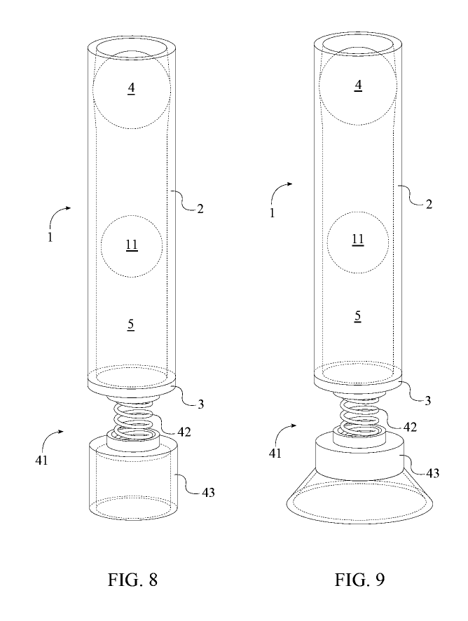

In order to provide additional methods of use, the psyche trainer may further comprise a support base 41, such that the psyche trainer can be attached to a variety of objects. The support base 41 is connected to the container 1 and can be positioned adjacent to the first end cap 3 or the second end cap 4. The design of the support base 41 can be adapted for use with multiple objects. The support base 41 may comprise an oscillating spring 42 and a mounting apparatus 43. The oscillating spring 42 is connected to the container 1 and provides the psyche trainer with six degrees of freedom. Connected to the oscillating spring 42 opposite of the container 1 is the mounting apparatus 43, which provides a means of connection to a variety of objects. In reference to FIG. 8, the mounting apparatus 43 is designed to be attached to a pencil or pen as an end cap. Motion of the pencil or pen will cause the oscillating spring 42 of the support base 41 to move, which will cause the psyche trainer to move and produce an audible noise. The psyche trainer then functions as a constant mental reminder, as well as a fun and stylistic pencil attachment.

In reference to FIG. 9, the mounting apparatus 43 is a suction cup. The psyche trainer can then be attached to any flat surface. In this way the psyche trainer can be used as a stress reliever, decoration, etc. For example, the psyche trainer can be mounted to a desk using the suction cup. It can then be used as a miniature punching bag by flicking the container 1 or hitting the container 1 with a pen or pencil, which will then cause the psyche trainer to produce an audible noise. It is a small and discrete way for user's to relieve stress without leaving their desk.

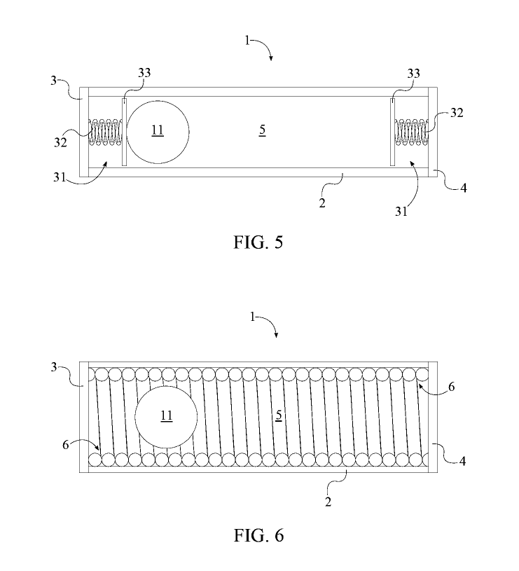

In reference to FIG. 5, the psyche trainer may further comprise at least one dampener 31. The at least one dampener 31 is connected to the container 1 and positioned within the tubular body 2. More specifically, each of the at least one dampener 31 is connected to the inside of either the first end cap 3 or the second end cap 4. The at least one dampener 31 acts to diffuse the audible noise produced from the at least one spherical body 11 coming in contact with either the first end cap 3 or the second end cap 4, without detracting too much from the motion of the at least one spherical body 11. In this way little to no audible noise is produced as the at least one spherical body 11 travels through the container 1, yet vibrations are still created and picked up by the user.

In one embodiment of the present invention, each of the at least one dampener 31 comprises a dampening spring 32 and a soft material 33. The dampening spring 32 is connected to the container 1, while the soft material 33 is adjacently connected to the dampening spring 32 opposite of the container 1. The dampening spring 32 can be designed to either increase the movement of the at least one spherical body 11 or to lessen the movement of the at least one spherical body 11 depending on the stiffness of the dampening spring 32. The soft material 33 reduces the audible noise produced from the at least one spherical body 11 contacting each end of the container 1. Alternatively, it is possible for the soft material 33 to be attached directly to the first end cap 3 and/or second end cap 4.

In other embodiments of the present invention, the container 1 further comprises a plurality of ridges 6, which are positioned within the tubular body 2 and along the guiding volume 5. The at least one spherical body 11 traverses over each of the plurality of ridges 6 as the at least one spherical body 11 moves along the guiding volume 5. The movement over each of the plurality of ridges 6 acts to intensify the vibrations created from the motion of the at least one spherical body 11 through the tubular body 2. The plurality of ridges 6 can be cut directly into the tubular body 2 or provided by an additional component of the container 1. In reference to FIG. 6, a body spring can be placed within the container 1 in order to provide the plurality of ridges 6. The body spring fits snuggly inside the container 1 and can be compressed or decompressed. The at least one spherical body 11 is then placed inside of the body spring. As the at least one spherical body 11 travels through the container 1, the at least one spherical body 11 travels over each coil of the body spring, thus intensifying the vibrations that are created from the motion of the at least one spherical body 11. This can be especially helpful in physical therapy applications of the invention where users may have decreased nerve function. In this way the psyche trainer can be used to help re-train nerves. It is also possible to use the body spring as the container 1 itself.

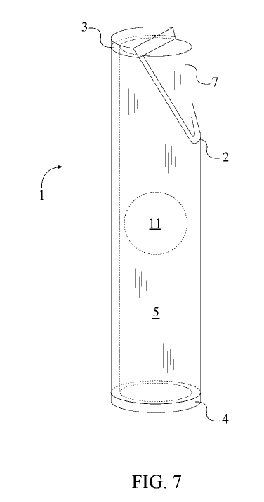

In reference to FIG. 7, the container 1 can be filled with a viscous liquid 7 in conjunction with the at least one spherical body 11. Any viscous liquid 7 can be used, such as glycerin or water. The viscous liquid 7 can be any color for stylistic purposes. The rate at which the movement of the at least one spherical body 11 is slowed depends on the viscosity of the viscous liquid 7. The use of a viscous liquid 7 also allows the psyche trainer to be alternatively used as an exercise device. For example, the psyche trainer can be held vertically as a weight. When the at least one spherical body 11 reaches the bottom end cap one repetition of the exercise has been completed. The psyche trainer can also be used as timer, similar to a hourglass, in this way.

Although the invention has been explained in relation to its preferred embodiment, it is to be understood that many other possible modifications and variations can be made without departing from the spirit and scope of the invention as hereinafter claimed.

What is claimed is:

1. A psyche trainer comprises:
a container;
an at least one spherical body;
the container comprises a tubular body, a first end cap, a second end cap, and a guiding volume;
the first end cap being adjacently connected to the tubular body;
the second end cap being adjacently connected to the tubular body opposite of the first end cap;
the guiding volume being positioned within the tubular body;
the guiding volume being positioned in between the first end cap and the second end cap; and
the at least one spherical body being movably positioned within the guiding volume.

2. The psyche trainer as claimed in claim 1 comprises:
a cord;
the cord comprises a first fastening end and a second fastening end;
the first fastening end being attached to the first end cap; and
the second fastening end being attached to the second end cap.

3. The psyche trainer as claimed in claim 1 comprises:
an at least one dampener;
the at least one dampener being connected to the container; and
the at least one dampener being positioned within the tubular body.

4. The psyche trainer as claimed in claim 3 comprises:
each of the at least one dampener comprises a dampening spring and a soft material;
the dampening spring being connected to the container; and
the soft material being adjacently connected to the dampening spring opposite of the container.

5. The psyche trainer as claimed in claim 1 comprises:
a support base;
the support base being connected to the container; and
the support base being positioned adjacent to the first end cap.

6. The psyche trainer as claimed in claim 5 comprises:
the support base comprises an oscillating spring and a mounting apparatus;
the oscillating spring being adjacently connected to the container; and
the mounting apparatus being connected to the oscillating spring opposite of the container.

7. The psyche trainer as claimed in claim 1 comprises:
the container further comprises a plurality of ridges;
the plurality of ridges being positioned within the tubular body; and
the plurality of ridges being positioned along the guiding volume.

8. The psyche trainer as claimed in claim 1 comprises:
the first end cap comprises a visual circuit;
the visual circuit comprises an at least one battery, a resistor, a bulb, and a pair of contacts;
the resistor, the bulb, and the pair of contacts being electrically connected to the at least one battery;
the pair of contacts being positioned within the guiding volume; and
the resistor, the bulb, and the at least one battery being positioned within the first end cap.

9. The psyche trainer as claimed in claim 1, wherein the guiding volume is filled with a viscous liquid.

10. A psyche trainer comprises:
a container;
an at least one spherical body;
a cord;
the container comprises a tubular body, a first end cap, a second end cap, and a guiding volume;
the cord comprises a first fastening end and a second fastening end;
the first end cap being adjacently connected to the tubular body;
the second end cap being adjacently connected to the tubular body opposite of the first end cap;
the guiding volume being positioned within the tubular body;
the guiding volume being positioned in between the first end cap and the second end cap;
the at least one spherical body being movably positioned within the guiding volume;
the first fastening end being attached to the first end cap; and
the second fastening end being attached to the second end cap.

11. The psyche trainer as claimed in claim 10 comprises:
the first end cap comprises a visual circuit;
the visual circuit comprises an at least one battery, a resistor, a bulb, and a pair of contacts;
the resistor, the bulb, and the pair of contacts being electrically connected to the at least one battery;
the pair of contacts being positioned within the guiding volume; and
the resistor, the bulb, and the at least one battery being positioned within the first end cap.

12. A method of using a psyche trainer comprises the steps of:
providing a psyche trainer, wherein the psyche trainer comprises a container, an at least one moving body, and a cord;
selecting a desired appendage on a human body, wherein said desired appendage is a right wrist, a left wrist, a right ankle, or a left ankle;
securing said container to said desired appendage with said cord;
selecting a goal to associate with said psyche trainer;
casually moving said human body whereby said at least one spherical body is set in motion within said container creating vibrations and an audible noise; and
associating said vibrations and said audible noise with said goal in order to become self aware as to achieve said goal.

13. The method of using a psyche trainer as claimed in claim 12 further comprises the steps of:
traversing said at least one spherical body along a guiding volume of said container in order to create said vibrations.

14. The method of using a psyche trainer as claimed in claim 12 further comprises the steps of:
contacting said at least one spherical body against a first end cap or a second end cap in order to create said audible noise.

15. The method of using a psyche trainer as claimed in claim 12 further comprises the steps of:
casually moving said human body whereby said at least one spherical body is set in motion within said container creating a visual signal; and
associating said visual signal with said goal in order to become self aware as to achieve said goal.

16. The method of using a psyche trainer as claimed in claim 15 further comprises the steps of:
engaging said at least one spherical body with a pair of contacts on a first end cap in order to complete a visual circuit and create the visual signal.

17. The method of using a psyche trainer as claimed in claim 12 further comprises the steps of:
providing said cord, wherein said cord has a predetermined length;
measuring said cord around said desired appendage; and
trimming said cord to fit snuggly around said desired appendage.

18. The method of using a psyche trainer as claimed in claim 12 further comprises the steps of:
attaching a first fastening end of said cord to a first end cap of said container;
encircling said desired appendage with said cord; and
attaching a second fastening end of said cord to a second end cap of said container.
